(19) United States
(12) Patent Application Publication
(10) Pub. No.: US 2023/0160362 A1
(43) Pub. Date: May 25, 2023

(54) WAVE ENERGY CONVERTER

(71) Applicant: Robert Bado, Delray Beach, FL (US)

(72) Inventors: Robert Bado, Delray Beach, FL (US); Artem Madatov, North Bethesda, MD (US)

(21) Appl. No.: 18/093,934

(22) Filed: Jan. 6, 2023

(51) Int. Cl. F03B 13/18; F03B 13/14

(52) U.S. Cl. CPC F03B 13/18; F03B 13/14

(57) ABSTRACT

The present invention is a wave energy converter capable of extracting useful energy from ocean waves by utilizing finite depth of ocean waves, kinetic energy of flowing water and drag force of water that opposes the relative motion of the submerged body through the water, comprising two bodies attached to each other, wherein the buoyant body is moored to the seabed, and the fully submerged body is suspended from the buoyant body by vertical suspender cables, chains, ropes, other flexible lines, or a rigid frame, and placed at a depth of around one-half wavelength of the prevailing waves at the installation site, where the water is not affected by the surface wave action, therefore is still or relatively still.

### FIELD OF THE INVENTION

This invention relates to devices for converting the energy of water waves into electricity.

### BACKGROUND OF THE INVENTION

The current energy mix must undergo fundamental revisions in order to preserve our way of life. Currently approximately 80% of the world's energy consumption is based on coal, petroleum and natural gas, which contain fossil carbon.

Environmental damage and increasing energy demand, causing the depletion of fossil fuels and thus the rise in costs, are contributing to the increasing development of renewable energy systems that capture energy from renewable natural resources, including ocean waves, hydro, wind and sunlight, and convert it into electricity.

Every continent on the planet is surrounded by a cleaner, safer, more efficient answer to our energy needs. The ocean holds a tremendous amount of untapped energy.

Ocean energy comes in a variety of forms such as marine currents, tidal currents, geothermal vents, and waves. Wave energy is generally considered to be the most concentrated and least variable form of renewable energy. Waves are predictable days and even months in advance making it easy to match supply and demand.

As water is approximately 800 times denser than air, the energy density of waves vastly exceeds that of wind, dramatically increasing the amount of energy available for harvesting.

The World Energy Council has estimated that approximately 2 Terawatts (2 million megawatts), about double current world electricity production, could be produced from the ocean waves.

There are currently several approaches, in different stages of development, for capturing wave energy and converting it into electricity. Methods for generating electricity from wave energy can be divided into two general categories: onshore systems and offshore systems.

Onshore systems are located at the edge of the shore, often on a sea cliff or a breakwater, and typically must concentrate the wave energy first before using it to drive an electrical generator. As waves approach the shore, the energy in the waves decreases; therefore, onshore wave power stations do not take full advantage of the amount of energy that waves in deeper water produce. In addition, there are a limited number of suitable sites for onshore systems and there are environmental and possible aesthetic issues with these wave power stations due to their size and location on the seashore.

Offshore systems are typically located from several hundred yards (meters) to several miles (kilometers) offshore. The wave energy conversion system can be located above, on or below the ocean surface.

One of the well-known technologies for harnessing the kinetic energy of water relies upon a water wheel system. Long used in water streams to generate power, those systems were placed in a continuous current. The water driven by the current pushes against the vanes or buckets installed around the perimeter of the wheel. This force causes the wheel to turn.

Many attempts have been made to harness the energy of water waves by water-wheel devices by positioning them directly into the path of the surface waves.

Adapting water wheel technology to the oceans has proven difficult for a variety of reasons. First, the braking of the ocean waves can swamp the water wheel therefore applying equal force to vanes or buckets on opposite sides of the wheel. No force imbalance is created, so the water wheel does not spin. Second, known systems ordinarily make no provision for utilizing both the kinetic and potential energy of the waves. Further, many of these technologies only work in relatively high waves, making the systems impractical for many areas with low or inconsistent wave heights. Finally, the water wheel, as well as any other energy harnessing device installed at the ocean or sea surface is exposed to destructive forces of nature.

The present invention addresses the above stated issues, as well as other problems related to wave energy conversion, and provides a system that efficiently extracts energy from a wide range of ocean wave heights at a low cost, and is capable of withstanding the most powerful storms.

### SUMMARY OF THE INVENTION

The present invention is a wave energy converter capable of extracting useful energy from ocean waves by utilizing finite depth of ocean waves, kinetic energy of flowing water and drag force of water that opposes the relative motion of the submerged body through the water.

Motion of water beneath the surface decreases exponentially with depth. No matter how agitated the water surface is, water at a depth of one-half wavelength L/2 (wave base) and below is motionless.

The wave energy converter comprises two bodies attached to each other. The first body is a moored to the seabed buoyant body. Suspended from the buoyant body by vertical suspender cables, chains, ropes, other flexible lines, or a rigid frame, is a fully submerged second body, comprising at least one electric generator, and at least one horizontally-aligned modular, preferably frame-foldable cylindrical rotor with a plurality of variable geometry scoop-shaped buckets, preferably made of a flexible or otherwise elastic material, that are attached to a lateral surface of the said rotor, and are tangentially and unidirectionally placed around the rotor, and evenly spread across the lateral surface of the rotor.

The submerged body is placed at a depth where the water is not affected by the surface wave action, therefore is still or relatively still. Preferably, the submerged body is placed at a depth of around one-half wavelength of the prevailing waves at the installation site.

The present invention is based on the fact that water waves have only a finite depth. The motion of water beneath the surface decreases exponentially with depth.

The present invention utilizes the water resistance (drag) that opposes the relative motion of the submerged body through the water. Drag forces act in a direction opposite to the oncoming flow velocity.

The buoyant body rises with each wave dragging the attached submerged body upward through the region of stationary water until a wave reaches its crest. As a wave falls, the gravity drags the said submerged body downward through the region of stationary water until a wave reaches its trough. The suspender cables, chains, ropes or other flexible lines are under constant tension due to multiple opposing forces i.e. buoyancy, gravity, drag.

This up and down motion through a region of stationary water causes rotation of the rotor with attached variable geometry buckets that are so shaped to move through the water with minimum resistance in one direction and with maximum resistance in the opposite direction. Each variable geometry bucket is preferably scoop-shaped, and thus is open on one side and closed on all others.

In the preferred embodiment, these variable geometry buckets are made of a flexible or otherwise elastic material. The said buckets might include a rigid material.

The plurality of said buckets is attached to, or is an integral part of a lateral surface of the rotor and is evenly distributed around the rotor from end to end. All buckets attached to the rotor are so placed to be open in the same direction. As a result, the rotor will always turn in the same direction, regardless of the direction of the movement to which it is subjected by the movements of the buoyant body under the influence of the passing waves.

Each rotor has a modular, preferably foldable inner frame thus improving transportability and reducing transportation cost. The said lateral surface of the rotor is fabricated either as a single element preferably made of a flexible or otherwise elastic material and securely attached to the said frame, or, alternatively, as a plurality of flexible, semi-flexible or rigid surface elements that are securely attached to the frame.

This rotation of the rotor is transmitted directly, or through a gear or another rotation transferring system to an electric generator or a group of such generators installed on the submerged body. The said generator is equipped with a flywheel and an overrunning clutch, ensuring its smooth and consistent rotation.

The buoyant body, which is moored to the seabed, is so designed and shaped to provide minimum resistance to the passing waves. The buoyant body is preferably of modular design, and comprises a plurality of smaller buoyant bodies attached to each other, thus improving survivability, transportability and reducing transportation cost.

Other systems, objects, methods, features and advantages of the invention will be, or will become, apparent upon examination of the following figures and detailed description. It is intended that all such additional systems, objects, methods, features and advantages be included within this description and this summary, be within the scope of the invention, and be protected by the following claims.

### BRIEF DESCRIPTION OF THE DRAWINGS

The invention can be better understood with reference to the following drawings and description. The components in the figures are not necessarily to scale. Emphasis instead being placed upon illustrating the principles of the invention.

FIG. 1 is a schematic drawing of the wave energy converter in operation, moving upward.

FIG. 2 is a schematic drawing of the wave energy converter, moving downward.

FIG. 3 is a perspective view of the rotor parts.

FIG. 4 is a perspective view of the lateral surface of the rotor with an integrated plurality of buckets.

### DETAILED DESCRIPTION OF THE INVENTION

The motion of water beneath the surface decreases exponentially with depth. Ocean waves have only a finite depth. No matter how significant is a wave action on the water surface, at the same time the water at a certain depth is calm. In general, the wave power below sea level decays exponentially by −2πd/L where d is the depth below sea level, and L is a wavelength. This property is valid for waves in deep water with depths greater than L/2 i.e. ocean.

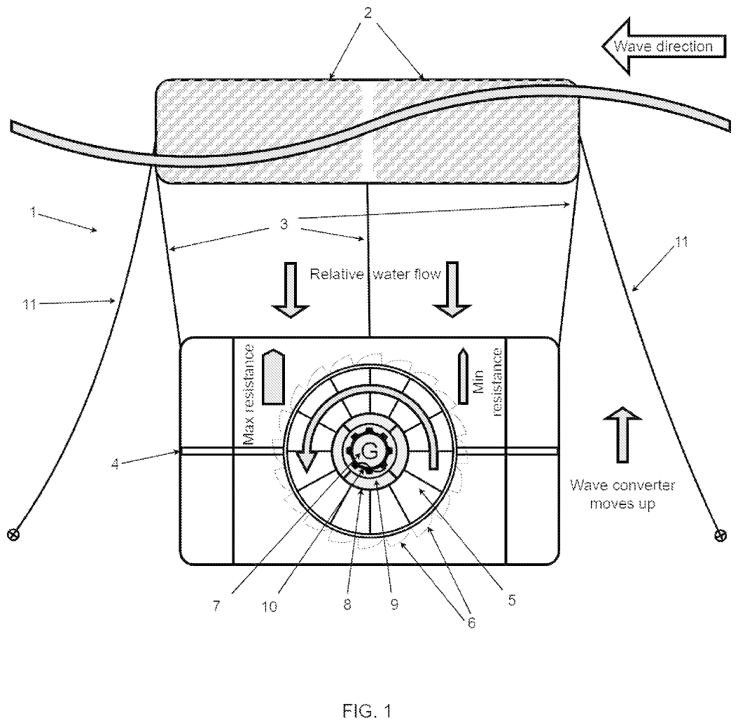

The wave energy converter 1 comprises two bodies attached to each other. The buoyant body 2 is moored to the seabed. Suspended from the buoyant body by vertical suspender cables, chains, ropes, other flexible lines 3, or alternatively using a rigid frame, is a fully submerged body 4, comprising at least one horizontally-aligned modular, preferably frame-foldable cylindrical rotor 5 with a plurality of variable geometry scoop-shaped made of a flexible or otherwise elastic material buckets 6, tangentially and unidirectionally attached to a lateral surface of the rotor, at least one electric generator 7, equipped with a flywheel 8 and an overrunning clutch 9, ensuring smooth and consistent rotation of the generator (FIG. 1).

The buoyant body 2, is moored to the seabed by mooring cables 11, and is so shaped to provide minimum resistance to the passing waves. The said buoyant body is preferably of modular design, comprising a plurality of smaller buoyant modules attached to each other, thus improving survivability, transportability and reducing transportation cost.

The rotor 5 transfers rotation to the generator 7 directly, or through the gear 10 or another rotation transferring system.

In order to fully utilize the energy of passing ocean waves, the submerged body 4 is placed at a depth where the water is not affected by the waves, therefore is still or relatively still. Preferably, the submerged body 4 is placed at a depth of around one-half wavelength of the prevailing waves at the installation site.

As a wave rises (FIG. 1), the buoyant body 2 moves upward, dragging the attached submerged body 4 upward through the region of stationary water until the wave reaches its crest. The suspender cables (chains, ropes or other flexible lines) 3 are under constant tension due to multiple opposing forces i.e. buoyancy, gravity, drag.

The water resistance (drag) opposes the relative motion of the submerged body 4 with the installed rotor 5 through the water. Drag forces act in a direction opposite to the oncoming flow velocity.

Each variable geometry scoop-shaped bucket 6 is so shaped to provide maximum resistance to the oncoming relative water flow at its open end, and minimum resistance at its opposite closed end.

All buckets 6 attached to the rotor 5 are placed unidirectionally, thus their open ends face the same direction. As a result, the rotor 5 will always turn in the same direction, regardless of the direction of the movement of the submerged body 4 to which it is subjected by the movements of the buoyant body 2 under the influence of the passing waves.

This motion of the submerged body 4 through a region of stationary water causes rotation of the rotor 5. Thus, with the buckets 6 arranged as shown in (FIG. 1), it is evident that, as the rotor moves upward through water, the buckets on the left side of the rotor provide greater resistance to the relative flow of water than the closed buckets on the right side of the rotor. Drag coefficient of the bucket's closed end, that is shaped as a streamlined half-body (scoop, half-cone), is around 0.06. Drag coefficient of the bucket's open end, that is approximately shaped as a hollow half-sphere, is around 2.0. Due to a significant difference in drag forces applied to the open and closed ends of the bucket 6 on the opposite sides of the rotor 5, it results in a counterclockwise rotation of the rotor 5.

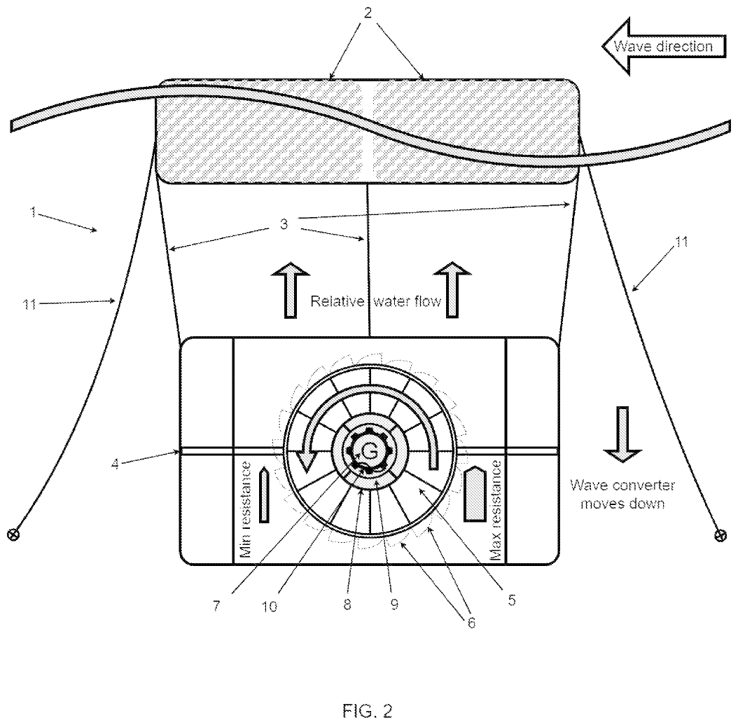

As a wave falls, (FIG. 2), the buoyant body 2 moves downward, the attached submerged body 4 is dragged downward through the region of stationary water by the force of gravity until the wave reaches its trough, opening the buckets 6 on the right side of the rotor 5, thus providing greater resistance to the relative water flow, than the buckets 6 on the left side of the rotor 5, forcing the rotor continue rotating counterclockwise.

This continuous unidirectional rotation of the rotor 5 with the attached variable geometry buckets 6 is transmitted by the gear 10, as shown in (FIG. 1) and (FIG. 2), to the electric generator 7, and is converted into a usable form of energy, electricity.

Alternatively, the said rotation of the rotor 5 through the gear 10 could drive a hydraulic pump or air compressor or any other energy converting device.

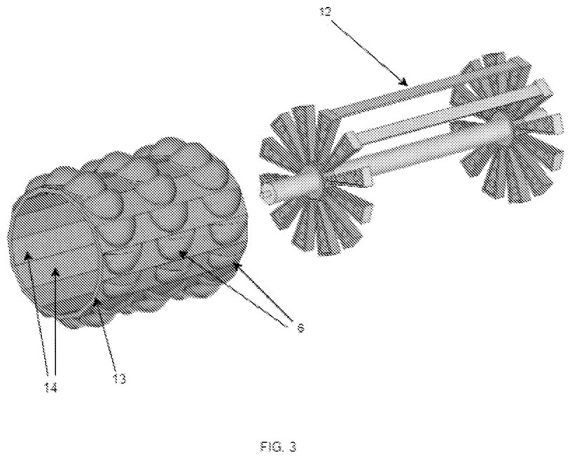

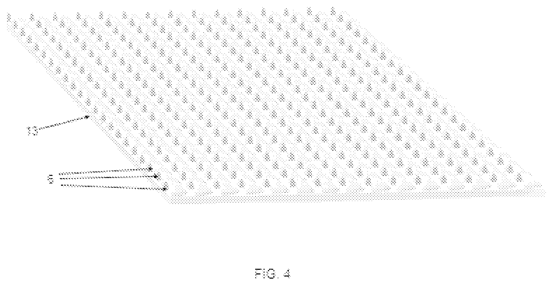

(FIG. 3) shows the said rotor, comprising a modular, preferably foldable frame 12 and a securely attached to it lateral surface 13 with buckets 6. In the preferred embodiment the lateral surface 13 is fabricated as a single element integrated with a plurality of buckets 6 made of a flexible or otherwise elastic material (FIG. 4).

Alternatively, the said lateral surface consists of a plurality of flexible, semi-flexible or rigid surface elements 14 securely attached to the frame, wherein, the said buckets 6 can be securely attached to the said elements 12 (FIG. 3).

The preceding detailed description is not intended to be limited to the specific embodiments set forth herein, but on the contrary, the description is intended to be exemplary, and it will be apparent to those of ordinary skill in the art that many more embodiments and implementations are possible that are within the scope of the invention. Accordingly, the invention is not to be restricted except in light of the attached claims and their equivalents.

1. A wave energy converter for converting the energy of ocean waves into electricity, comprising two bodies attached to each other, characterized in that the buoyant body is moored to the seabed, and the fully submerged body is suspended from the buoyant body by vertical suspender cables, chains, ropes, other flexible lines, or a rigid frame.

2. The fully submerged body according to claim 1, comprising at least one electric generator, at least one horizontally-aligned cylindrical rotor, at least one flywheel and at least one overrunning clutch, characterized in that, the submerged body is placed at a depth where the water is not affected by the waves, therefore is relatively still.

3. The fully submerged body according to claims 1 and 2, characterized in that the rotor and the generator are so placed and connected to each other within the submerged body that rotation of the rotor is transferred to the generator either directly or through a gear.

4. The rotor according to claim 2, characterized in that a plurality of variable geometry scoop-shaped buckets is attached to a lateral surface of the rotor, and are tangentially and unidirectionally placed around the rotor, and evenly spread across the lateral surface of the rotor.

5. The rotor according to claim 2, characterized in that the rotor has a modular, foldable inner frame.
